(19) United States
(12) Patent Application Publication
(10) Pub. No.: US 2025/0328749 A1
(43) Pub. Date: Oct. 23, 2025

(54) FEATURE TEMPLATE STORE FOR PREDICTIVE MODELS

(71) Applicant: Express Scripts Strategic Development, Inc., St. Louis, MO (US)

(72) Inventors: Cameron Wellock, New York, NY (US); Robin Todd, Austin, TX (US); Anahi Garnelo, New York, NY (US); David Lucero, Queens, NY (US)

(21) Appl. No.: 18/640,893

(22) Filed: Apr. 19, 2024

(51) Int. Cl. G06N 3/044; G06N 3/045; G06Q 40/08

(52) U.S. Cl. CPC G06N 3/044; G06N 3/045; G06Q 40/08

(57) ABSTRACT

A computer system includes a database configured to store a feature template repository including multiple feature templates configured for building predictive models, where each feature template includes a parameterized SQL query. The computer system includes processor hardware configured to search the feature template repository for a target predictive model feature, and in response to a determination that the target predictive model feature does not have a matching feature template in the feature template repository, create a new feature template for the target predictive model feature by defining feature logic for the new feature template and defining an SQL query for the new feature template. The processor hardware is configured to submit the new feature template for approval by generating a notification including a repository link, and in response to receiving an approval, upload the new feature template to the feature template repository for use in building predictive models.

### FIELD

The present disclosure relates to feature template stores for predictive models.

### BACKGROUND

Data scientists and data engineers work to develop predictive models. Often, data scientists provide instructions for predictive models, but do not directly control the final predictive model product. Feature engineering is a significant portion of a predictive model lifecycle, which may include model development and model production.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer system includes a database configured to store a feature template repository, the feature template repository including multiple feature templates configured for building predictive models, and each of the multiple feature templates including a parameterized structured query language (SQL) query. The computer system includes processor hardware configured to execute instructions to search the feature template repository for a target predictive model feature, and in response to a determination that the target predictive model feature does not have a matching feature template in the feature template repository, create a new feature template for the target predictive model feature by defining feature logic for the new feature template and defining an SQL query for the new feature template. The processor hardware is configured to submit the new feature template for approval by generating a notification including a repository link, and in response to receiving an approval, upload the new feature template to the feature template repository for use in building predictive models.

In other features, the processor hardware is configured to execute a predictive model including at least one predictive model feature based on the new feature template uploaded to the feature template repository. In other features, the new feature template includes a template folder structure including an SQL folder and a configuration folder.

In other features, the SQL folder is configured to store an SQL file including the SQL query defined for the new feature template, and the configuration folder is configured to store a configuration file including one or more parameters of the SQL query. In other features, the template folder structure includes a builder folder, and the builder folder is configured to store a builder file defining at least one non-SQL processing function.

In other features, the processor hardware is configured to execute the new feature template via an Auchan application programming interface (API) (e.g., the Auchan library developed by CIGNA). In other features, the processor hardware is configured to return output features as a Spark feature table.

In other features, in response to a determination that the target predictive model feature has a matching feature template in the feature template repository, the processor hardware is configured to implement the matching feature template as a portion of a predictive model.

In other features, creating the new feature template includes identifying one or more parameters associated with target predictive model feature. In other features, the one or more parameters include at least one healthcare claim parameter. In other features, in response to a receiving a denial subsequent to submitting the new feature template, the processor hardware is configured to modify the new feature template and resubmit the modified new feature template for approval.

A method for predictive model feature template creation includes searching a feature template repository for a target predictive model feature, the feature template repository including multiple feature templates configured for building predictive models, each of the multiple feature templates including a parameterized structured query language (SQL) query, in response to a determination that the target predictive model feature does not have a matching feature template in the feature template repository, creating a new feature template for the target predictive model feature by defining feature logic for the new feature template and defining an SQL query for the new feature template, submitting the new feature template for approval by generating a notification including a repository link, and in response to receiving an approval, uploading the new feature template to the feature template repository for use in building predictive models.

In other features, the method includes executing a predictive model including at least one predictive model feature based on the new feature template uploaded to the feature template repository.

In other features, the new feature template includes a template folder structure including an SQL folder and a configuration folder. In other features, the SQL folder is configured to store an SQL file including the SQL query defined for the new feature template, and the configuration folder is configured to store a configuration file including one or more parameters of the SQL query. In other features, the template folder structure includes a builder folder, and the builder folder is configured to store a builder file defining at least one non-SQL processing function.

In other features, the method includes executing the new feature template via an Auchan application programming interface (API). In other features, the method includes returning output features as a Spark feature table.

In other features, in response to a determination that the target predictive model feature has a matching feature template in the feature template repository, the method includes implementing the matching feature template as a portion of a predictive model. In other features, creating the new feature template includes identifying one or more parameters associated with target predictive model feature.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system including a high-volume pharmacy.

FIG. 2 is a functional block diagram of an example pharmacy fulfillment device, which may be deployed within the system of FIG. 1.

FIG. 3 is a functional block diagram of an example order processing device, which may be deployed within the system of FIG. 1.

FIG. 4 is a functional block diagram of an example system including a feature template store for database management.

FIG. 5 is a functional block diagram of a combination of multiple features from various feature templates.

FIG. 6 is a functional block diagram of an example execution environment for implementing a feature template store for database management.

FIG. 7 is a flowchart depicting an example process for creating and uploading feature templates.

FIG. 8 is a flow chart depicting an example process for creating a feature template in the process of FIG. 7.

FIG. 9 is a flow chart depicting an example process for creating a feature template in the process of FIG. 7.

FIG. 10 is a flow chart depicting an example process for creating a feature template in the process of FIG. 7.

FIG. 11 is a block diagram of an example service of feature template management platform that may be deployed within the system of FIG. 4.

FIG. 12 is a functional block diagram of an example neural network that can be used for an inference engine or other functions to produce a predictive model.

In the drawings, reference numbers may be reused to identify similar and/or identical elements.

### DETAILED DESCRIPTION

### High-Volume Pharmacy

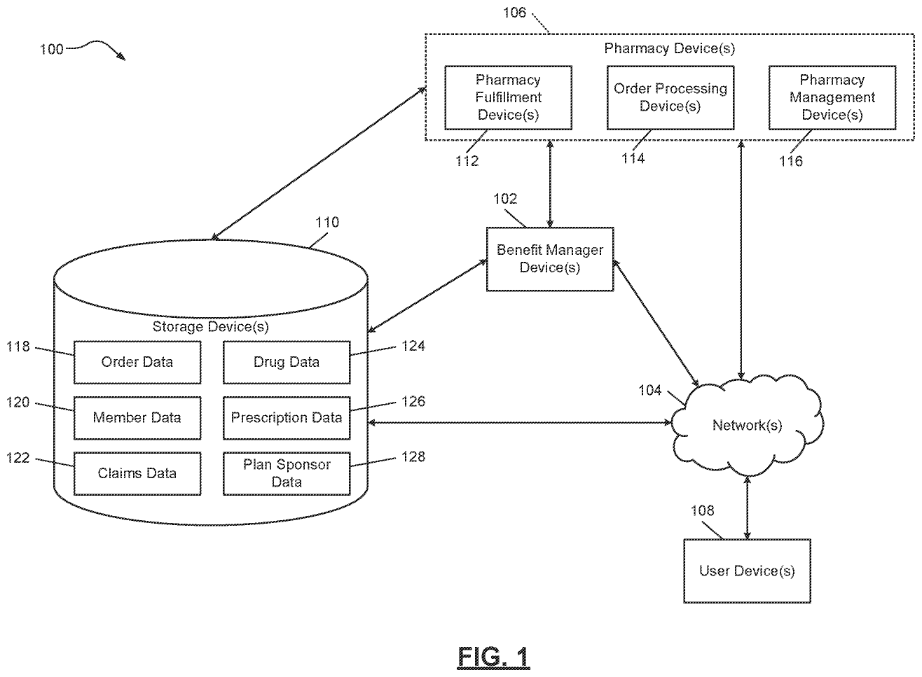

FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, etc.). A high-volume pharmacy may be a pharmacy that is capable of filling at least some prescriptions mechanically. The system 100 may include a benefit manager device 102 and a pharmacy device 106 in communication with each other directly and/or over a network 104.

The system 100 may also include one or more user device(s) 108. A user, such as a pharmacist, patient, data analyst, health plan administrator, etc., may access the benefit manager device 102 or the pharmacy device 106 using the user device 108. The user device 108 may be a desktop computer, a laptop computer, a tablet, a smartphone, etc.

The benefit manager device 102 is a device operated by an entity that is at least partially responsible for creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in a storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the pharmacy system 100) following performance of at least some of the aforementioned operations.

As part of the adjudication, a plan sponsor (or the PBM on behalf of the plan sponsor) ultimately reimburses the pharmacy for filling the prescription drug when the prescription drug is successfully adjudicated. The aforementioned adjudication operations generally occur before the copayment is received and the prescription drug is dispensed. However, in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Virginia.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfillment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. The order processing device 114 is dedicated to performing processes, methods, and/or instructions described in this application. Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, and/or plan sponsor data 128. Further, the system 100 may include additional devices, which may communicate with each other directly or over the network 104.

The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, address, telephone number, e-mail address, prescription drug history, etc. The member data 120 may include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally, or alternatively, the claims data 122 may include claims that have been de-identified (that is, associated with a unique identifier but not with a particular, identifiable member).

The drug data 124 may include drug name (e.g., technical name and/or common name), other names by which the drug is known, active ingredients, an image of the drug (such as in pill form), etc. The drug data 124 may include information associated with a single medication or multiple medications.

The prescription data 126 may include information regarding prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

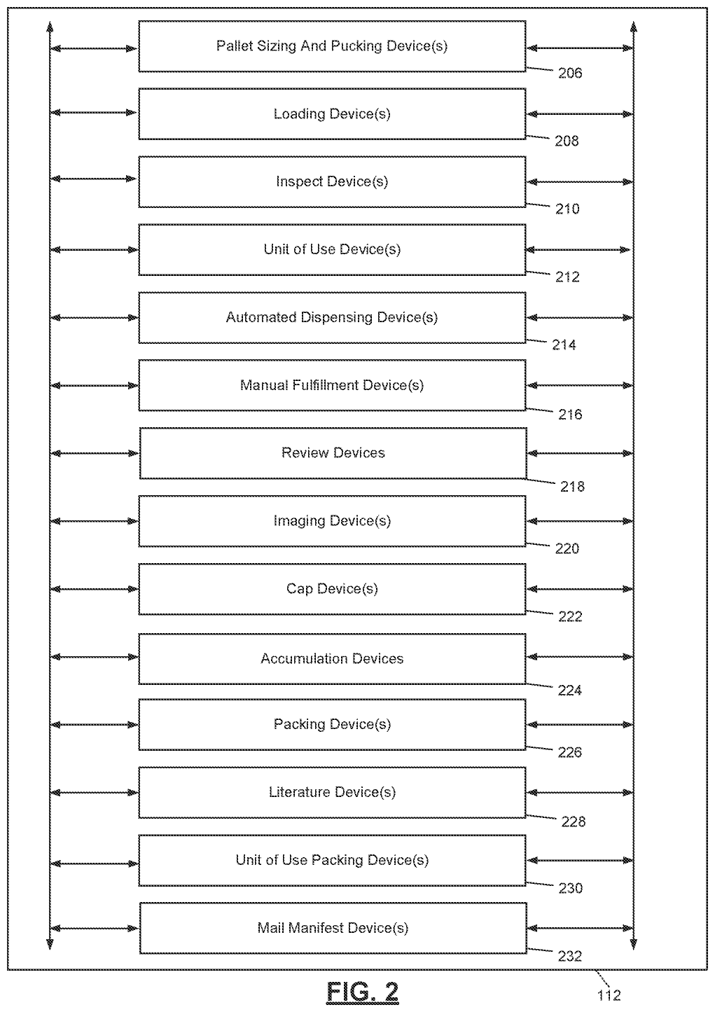

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model. The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

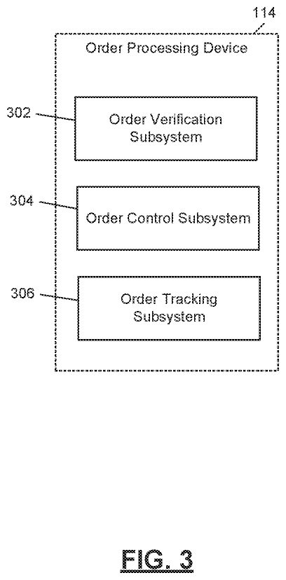

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order related information. For example, the prescription order may be comprised of order components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors: for example, to deliver the pallet from the loading device 208 to the manual fulfillment device 216 from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

### Feature Template Store System

In some example embodiments, a feature template store framework facilitates and simplifies interactions between data science feature engineering instructions, and resulting features created by engineers. For example, data scientists may provide instructions for predictive models, but do not directly control the final predictive model product. Engineers may not know whether there are any issues in generating a predictive model, even if they follow instructions and understand what the final product is.

A feature template store (FTS) may provide a solution to both sides of the problem by using a shared framework of templatized feature generation code, and an internally developed python package. Data scientists may develop new model features or leverage existing templates with parameters customized to their needs. Data engineers may make minimal changes to the features to bring the models to production. This approach reduces time and cost to develop and operationalize predictive models. For example, in one model development process the feature template store was able to reduce the model development and deployment lifecycle by 79%, from 28 weeks to 6 weeks. In various implementations, the feature template store framework may drastically improve efficiency as well as additional use cases that demonstrate the reusability and standardization of code between groups and models.

In various implementations, a feature template store may be considered as a parameterized and standardized query store hosting a single source of true queries. It may be designed to run through an analytics platform via a Domino or Databricks workspace, for example, using Python. The feature template store may help align the process of feature development and operationalization across data engineering and data science verticals. For example, feature templates may be created by users, certified by data subject matter experts through an intake and review process, and then made available for use by all developers.

Features are often re-used across model development and other advanced analytic workflows. Feature engineering can consume up to eighty percent of analytic workflow. Often, there is no singular, centralized place to search for features, and traditional repositories can be challenging to maintain based on streams of claims data.

The feature template store may facilitate increasing productivity, lowering deployment timelines, and providing more consistent models. For example, data scientists and data engineers may be aligned by sharing definitions and avoiding recoding during operationalization, and different business vertical teams may leverage work of others and eliminate duplicated efforts.

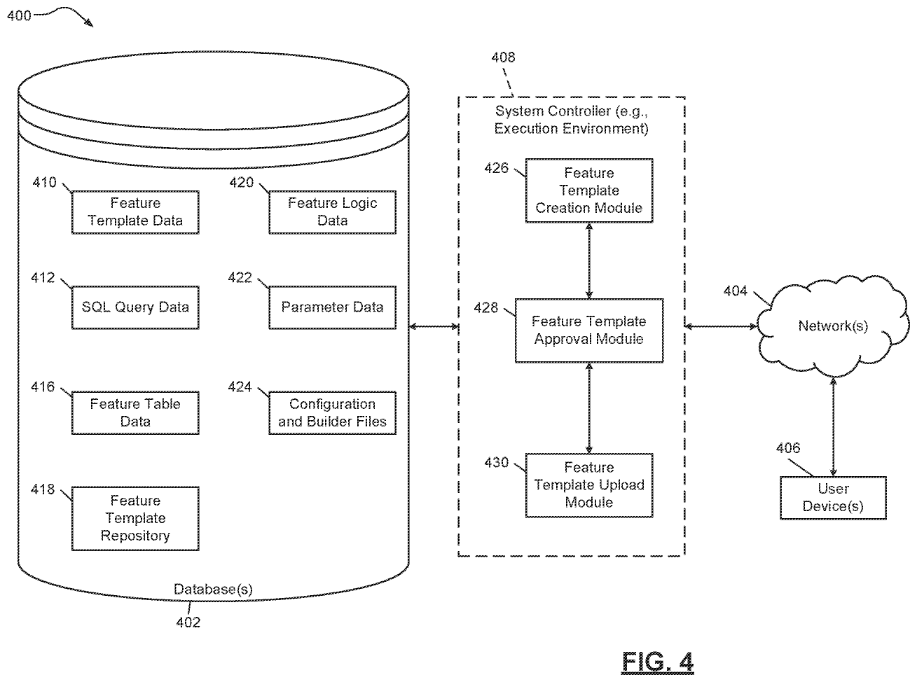

FIG. 4 is a functional block diagram of an example system 400 for including a feature template store for database management, which includes a database 402. While the system 400 is generally described as being deployed in a computer network system, the database 402 and/or components of the system 400 may otherwise be deployed (for example, as a standalone computer setup). The system 400 may include a desktop computer, a laptop computer, a tablet, a smartphone, etc.

As shown in FIG. 4, the database 402 stores feature template data 410, SQL query data 412, feature table data 416, a feature template repository 418, feature logic data 420, parameter data 422, and configuration and builder files 424. In various implementations, the database 402 may store other types of data as well, or may not store all of the example data types illustrated in FIG. 4.

The feature template data 410, SQL query data 412, feature table data 416, feature template repository 418, feature logic data 420, parameter data 422, and configuration and builder files 424 may be located in different physical memories within the database 402, such as different random access memory (RAM), read-only memory (ROM), a non-volatile hard disk or flash memory, etc. In some implementations, the feature template data 410, SQL query data 412, feature table data 416, feature template repository 418, feature logic data 420, parameter data 422, and configuration and builder files 424 may be located in the same memory (such as in different address ranges of the same memory). In various implementations, the feature template data 410, SQL query data 412, feature table data 416, feature template repository 418, feature logic data 420, parameter data 422, and configuration and builder files 424 may each be stored as structured or unstructured data in any suitable type of data store.

In some example embodiments, a feature template store may include two or more main components: the actual feature templates themselves, and an Auchan library which allows a user to interact with and execute the templates (e.g., the Auchan library developed by CIGNA). Referring to FIG. 4, the feature template data 410 may include any data suitable for creating new feature templates. The newly created feature templates may be stored in the feature template repository 418, such as a feature template store (FTS) GitHub repository. Each feature template may create more than one feature.

The structured query language (SQL) query data 412 may include any data suitable for building SQL queries for feature templates. For example, each feature template may be a parameterizable SQL query. The feature logic data 420 may include any suitable data for defining logical operation of feature templates.

In some examples, the feature logic data 420 may include SQL code used to create a feature. Additional logic may include Python or Pyspark code. Example use cases may include, but are not limited to, handling feature templates that require special naming considerations (such as a special character in a parameter than needs to be appended to a feature name), using non-SQL logic (which provides more flexibility for feature templates that cannot be created easily with SQL alone), etc.

The parameter data 422 may include any suitable parameters which may be incorporated in feature templates, accessed or received as inputs by feature templates, etc. The configuration and builder files 424 may be files which are created as part of feature templates, in order to implement the feature templates.

In some embodiments, a specific template directory structure may be used, such as where an Auchan package expects a specific template directory for proper operation. In an example, a feature template directory may have three subfolders, where a glossary .yaml file may not be needed.

A configuration (or config) folder may contain configuration information for each feature template. The configuration (or config) file may contain information about each feature that the template creates, and what parameters are available for that template. There may be one config file per template, which may be in a yaml format.

An SQL folder may contain SQL queries for each template. A template may include multiple SQL queries that can run sequentially as specified in the template config file. Each template may consist of two main files: an SQL file which is a parameterized SQL query, and a config file which includes parameters/options for the SQL query.

A builder folder may include builder files (e.g., Python builder files) for any templates that need additional logic outside of SQL code. The builder files may be used to specify special naming conventions, such as removing special characters. In some examples, only a builder file may be used to define the logic for the feature, avoiding SQL code altogether.

In some example embodiments, an Auchan package (e.g., Auchan python library) may be used to allow a user to interact with feature templates, such as an Auchan application programming interface (API) which allows execution of feature templates. Auchan may handle a connection to data sources, such as in S3 or TDV. Auchan may be configured to load available feature templates from a template directory, and allow a user to execute a chosen template. The user may be able to set different parameter values for each feature.

Output may be returned as a spark data frame, which may be ready for model development. For example, the Auchan API may return a spark data frame or other data object. The Auchan API may interface with a Jupyter notebook, .py file, or other suitable file containing code. In some examples, engineering may use feature templates and Auchan for productionalizing models, where no recoding is necessary. The feature template store may be configured to run on an enterprise analytics platform (EAP) with python.

As shown in FIG. 4, a system controller 408 may include one or more modules, including a feature template creation module 426, a feature template approval module 428, and a feature template upload module 430. These example modules are provided for purposes of illustration, and other embodiments may include more or less modules, functions of different software features implemented in other modules or controller locations, more than one system controller, more than one database, data distributed to other databases, etc.

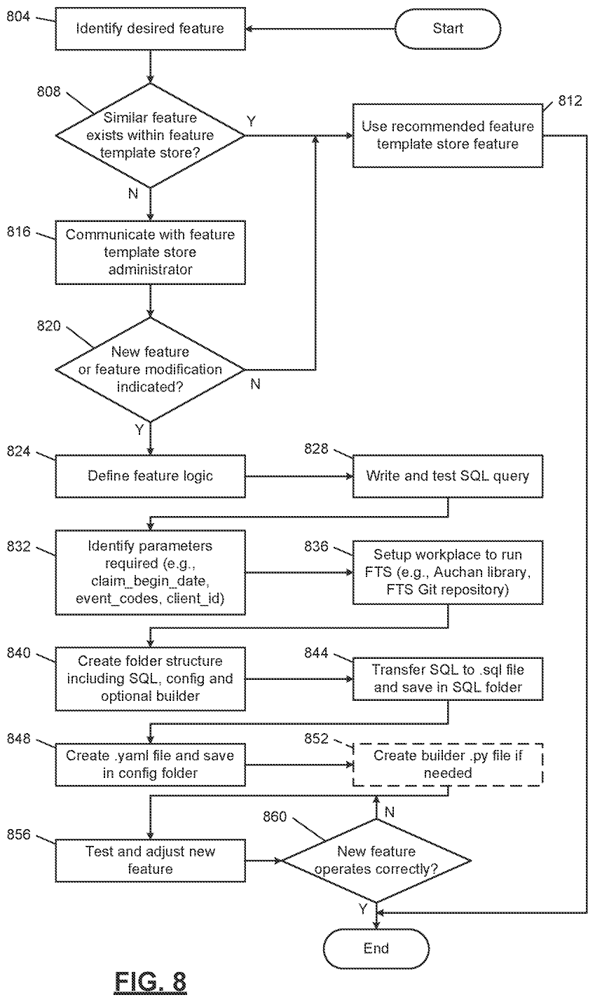

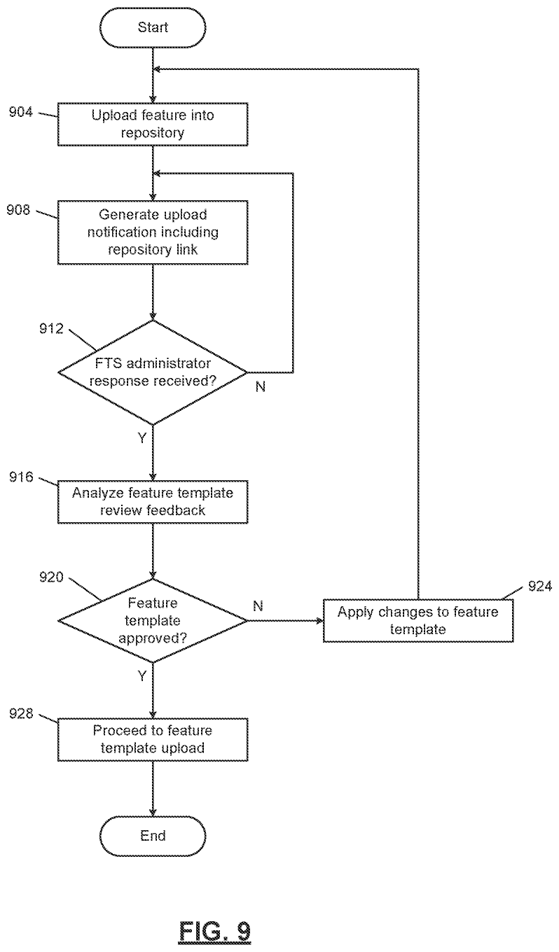

The feature template creation module 426 may be used to create new feature templates. Example details regarding feature template creation are provided further below with reference to FIG. 8. The feature template approval module 428 may be used for review and approval of newly created feature templates. Example details regarding feature template review and approval are provided further below with reference to FIG. 9. The feature template upload module 430 may be used to upload approved feature templates, such as for use in models, for use in developing predictive models, for use in execution of software code or modules, for database management or processing, etc.

In various implementations, a system developer may create feature templates by accessing the system controller 408 via the user device 406. The user device 406 may include any suitable user device for displaying text and receiving input from a user, including a desktop computer, a laptop computer, a tablet, a smartphone, etc. In various implementations, the user device 406 may access the database 402 or the system controller 408 directly, or may access the database 402 or the system controller 408 through one or more networks 404. Example networks may include a wireless network, a local area network (LAN), the Internet, a cellular network, etc.

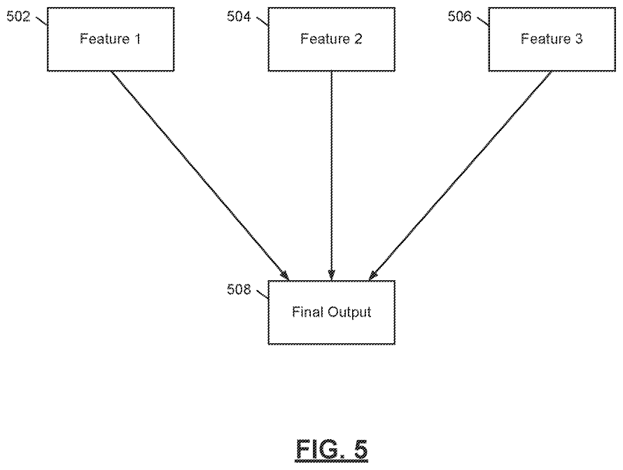

FIG. 5 is a functional block diagram of a combination of multiple features from various feature templates. As shown in the example of FIG. 5, a first feature 502, a second feature 504, and a third feature 506, are combined to generate a final output 508.

Each of the first feature 502, the second feature 504, and the third feature 506, may correspond to various feature templates which have been created over time by users, and uploaded to the feature template store. The final output 508 may be a module used for development of predictive models, for execution of software code, for management or processing of a database, or any other suitable purpose for the feature templates. For example, each of the first feature 502, the second feature 504, and the third feature 506 may include different functionality that a developer would like to include in a module of the final output 508.

In some example embodiments, each feature template is independent, and may be run concurrently. For example, the final output 508 may include independent feature templates for the first feature 502, the second feature 504, and the third feature 506, which run concurrently in the final output 508.

In various implementations, each feature template may be a parameterizable SQL query. For example, a feature template store may include many different feature templates, such as at least ten different feature templates, at least fifty different feature templates, at least one hundred different feature templates, etc., which have been uploaded to the feature template store. Example feature templates may include, but are not limited to, a feature template for an A1C period (a1c_timeperiod), a behavioral status period (behavioral_status_timeperiod), a body-mass index (BMI) period (bmi_timeperiod), demographic features (demographic_features_timeperiod), etc.

Parameterization capabilities may facilitate advantages for the implementation of feature templates. For example, for a feature such as “Customer age 3 months prior to account quote date”, lots of models may use “customer age” as a parameter, but few models may use the narrower “customer age 3 months prior to” a customer specific point in time.

Parameterization allows for redefining the feature as “Customer age {months_lag} months prior to {ref_date}.” This increases the number of models that can use the feature, where each model can choose its own value of {months_lag} and {ref_date}.

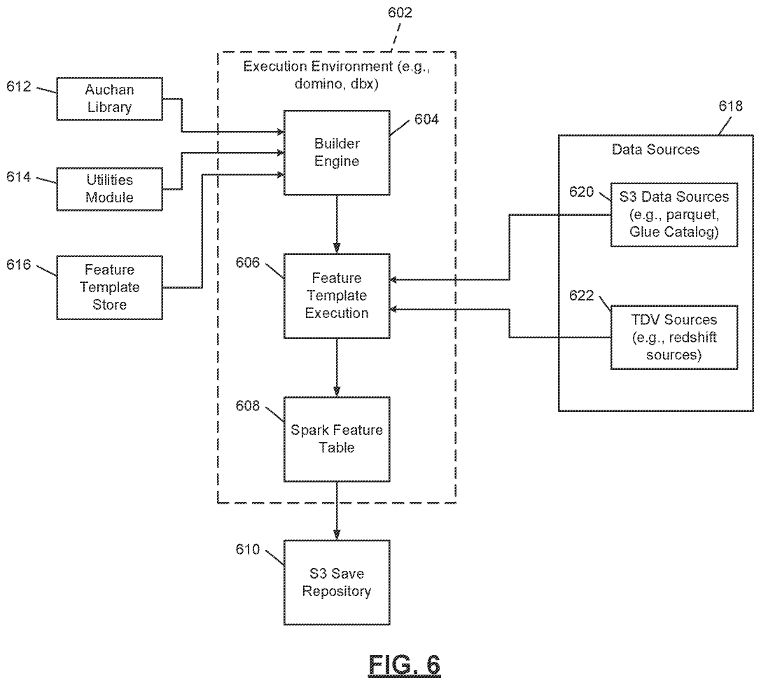

FIG. 6 is a functional block diagram of an example execution environment for implementing a feature template store for database management. As shown in FIG. 6, the execution environment 602 includes a builder engine 604, a feature template execution 606 and a spark feature table 608. The execution environment 602 may be any suitable execution environment, such as Domino, DBX, etc.

The builder engine 604 is configured to receive inputs from one or more modules, including an Auchan library 612, a utilities module 614, and a feature template store 616. For example, an execution environment may be built into ap_dbutils. Credentials may be handled differently between platforms. In some example embodiments, the feature template store 616 may be a repository, a package, etc.

The feature template execution 606 is configured to receive data from one or more data sources 618. For example, S3 data sources 620 may provide data to the feature template execution 606, such as Parquet, Glue Catalog, etc. TDV sources 622 may provide data to the feature template execution, such as redshift sources. Connections to data sources may be handled by ap_dbutils, for example, and Auchan can use whatever data source is configured via ap_dbutils.

After the builder engine 604 and the feature template execution 606 are executed in the execution environment 602, the spark feature table 608 may be used for supplying output data for upload to an S3 save repository 610. Although example database and execution tools are illustrated in FIG. 6, other example embodiments may use any suitable tools for execution and development.

### Feature Template Creation Processes

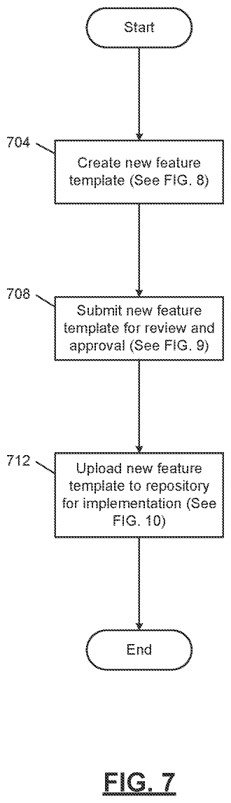

FIG. 7 is a flowchart depicting an example process for creating and uploading feature templates. In various implementations, the process of FIG. 7 may be executed by the system controller 408, such as the feature template creation module 426, the feature template approval module 428, and/or the feature template upload module 430.

At 704, the process begins by creation of a new feature template. Further details regarding creation of a new feature template are discussed further below with reference to FIG. 8. At 708, control submits the new feature template for review and approval. For example, an automated processing pipeline, development queue, etc. may be used to submit a new feature template to a review portal, review storage location, etc., once a new feature template has been created. Further details regarding review and approval of a newly created feature template are discussed further below with reference to FIG. 9.

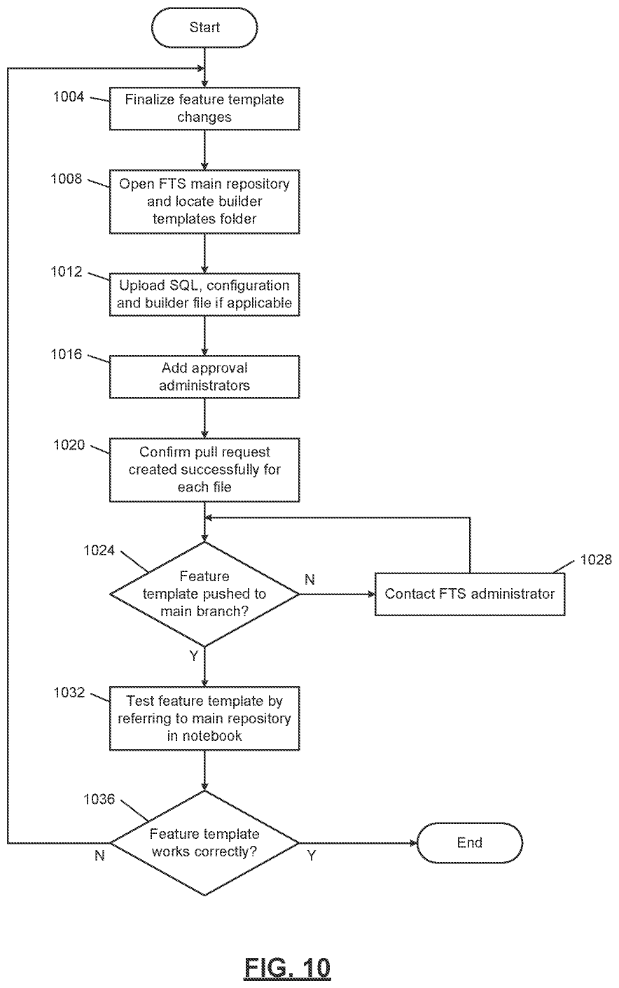

At 712, control is configured to upload the new feature template to a repository for implementation. For example, a newly created feature template may be automatically or manually uploaded to a development environment, repository (e.g., an FTS GitHub repository), data store, etc., once the feature template receives approval. The feature template may then be incorporated into new predictive modeling projects, used in new software code, used for new database management and processing features, etc. Further details regarding upload of new feature templates are discussed further below with reference to FIG. 10.

FIG. 8 is a flow chart depicting an example process for creating a feature template in the process of FIG. 7. In various implementations, the process of FIG. 8 may be executed by the system controller 408, such as the feature template creation module 426.

At 804, the process begins by identifying a desired feature, such as a new feature for database processing or management, a new feature for implementation in a predictive model development environment or software code execution, etc. At 808, control checks whether a similar feature exists within the feature template store. For example, a user may search the feature template store using keywords or other search criteria, an automated matching algorithm may determine whether any existing feature templates have a sufficient similarity score above a specified match threshold, etc.

If a similar feature already exists at 808, control proceeds to 812 to use the recommended feature template store feature at 812. For example, if a user finds a similar match to a desired feature that already exists in the feature template store, the user may select the matching feature for implementation in their development project, etc.

If a similar feature does not already exist at 808, control proceeds to 816 to communicate with a feature template store administrator. For example, a communication may be generated requesting creation of a new feature for the feature template store, based on the desired new feature.

At 820, control determines whether a new feature or feature modification has been indicated. For example, an administrator may review the request for a new feature, or existing feature modification, and approve or reject the request. If the new feature creation or feature modification is denied, control proceeds to 812 to select a closest match for the desired feature from existing features of the feature template store.

If the new feature or feature modification is accepted at 820, control proceeds to 824 to define logic for the feature. For example, a user may specify operation of the feature based on various parameters, inputs, outputs, etc. At 828, control receives a written structured query language (SQL) query, which may be tested by a user, tested by an automated test program, etc.

At 832, control identifies required parameters for the new feature, which may include parameters that need to be accessed to implement the feature. Example feature parameters may include, but are not limited to, a claim begin date (claim_begin_date), event codes (event_codes), a client identifier (client_id), etc.

Control sets up a workplace to run the feature template store, at 836. For example, a user may set up or access an Auchan library, a feature template store (FTS) Git repository, etc. Control then creates a folder structure at 840, which may include an SQL folder, a configuration folder, an optional builder folder, etc.

At 844, control is configured to transfer SQL data to a .sql file, and save the .sql file in an SQL folder. In some examples, parameters may be enclosed in curly brackets or other suitable characters, such as {claim_date}. At 848, control is configured to create a .yaml file, and save the .yaml file in a configuration folder. For example, information may be entered for feature names, parameters, an SQL source, etc. A description may be entered for each feature.

At 852, control optionally creates a builder .py file, if needed. For example, builder files may be needed if a feature needs special processing or functions. If a builder file is created, the builder name may be entered on the .yaml file under a name section, for example.

Control then tests and adjusts the new feature at 856. For example, the new feature may be subjected to one or more testing protocols to determine operation of the newly created feature. If the new feature does not operate correctly in response to testing at 860, control returns to 856 to continue testing and adjusting the new feature. Once the new feature operates correctly at 860 in response to testing, the process may proceed to a next step of review and approval, as described further below with reference to the example process illustrated in FIG. 9.

FIG. 9 is a flow chart depicting an example process for creating a feature template in the process of FIG. 7. In various implementations, the process of FIG. 9 may be executed by the system controller 408, such as the feature template approval module 428.

At 904, the process begins by uploading a newly created feature into a repository, such as a feature created using the example process of FIG. 8. In various implementations, the repository may be a github repository which is personal to the feature creator, and the feature creator may grant access to the repository to a feature template store team.

At 908, control proceeds by generating an upload notification including a repository link. For example, a communication (e.g., email, message, etc.) may be automatically or manually generated once the new feature is uploaded to the repository, for sending to a feature template store administrator to review the new feature using the link to the repository for accessing the new feature.

At 912, control determines whether a response has been received from the feature template store administrator. If not, control returns to 908 to generate another upload notification communication for sending to the administrator. This may happen on a periodically scheduled basis (such as every day, every week, etc.), or may happen based on manual checking by the feature creator. In some examples, a feature creator may be instructed to wait up to seven days (or a longer or shorter period of time), for a feature template store team to respond.

Once a response is received from the feature template store administrator at 912, control proceeds to 916 to analyze the feature template review feedback. For example, the feature template store administrator may provide a detailed explanation of why a new feature is or is not approved.

If the new feature template is not approved at 920, control proceeds to 924 to apply changes to the feature template. For example, the feature template may be modified to address issues raised in the review feedback from the feature template store administrator. Control then returns to 904 to upload the modified feature into the repository, for another round of review.

Once the feature is approved in the feature template review feedback at 920, control proceeds to 928 to upload the feature template (e.g., for implementation in predictive model development environments, for use in software code or for database management and processing, etc.). Further details regarding upload of approved feature templated are described below with reference to the example process illustrated in FIG. 10.

FIG. 10 is a flow chart depicting an example process for creating a feature template in the process of FIG. 7. In various implementations, the process of FIG. 10 may be executed by the system controller 408, such as the feature template upload module 430.

At 1004, the process begins by finalizing feature template changes. For example, a feature template creator may review the approved feature template to make sure all details for the feature template are ready for implementation. Control then opens a feature template store main repository at 1008, and locates a builder templates folder.

At 1012, control uploads an SQL file, a configuration file, and a builder file if applicable. Control then adds approval administrators at 1016, and confirms that a pull request was successfully created for each file at 1020.

At 1024, control determines whether the feature template has been pushed to a main branch. If not, a feature template store administrator is contacted at 1028, and control returns to 1024 to wait until the feature is pushed to the main branch. For example, in various implementations a feature template creator may be instructed to wait up to seven days (or longer or shorter) for a feature template store team to respond and push an approved finalized feature template to a main branch.

Once the feature template has been pushed to the main branch at 1024, control proceeds to 1032 to test the feature template, such as by referring to the main repository in a notebook. If the feature template does not work correctly at 1036, control returns to 1004 to adjust and finalize the feature template changes. Once the feature template works correctly at 1036, the feature template may be used in predictive model development environments, for software code execution, for database management and processing, etc.

### Machine Learning Models

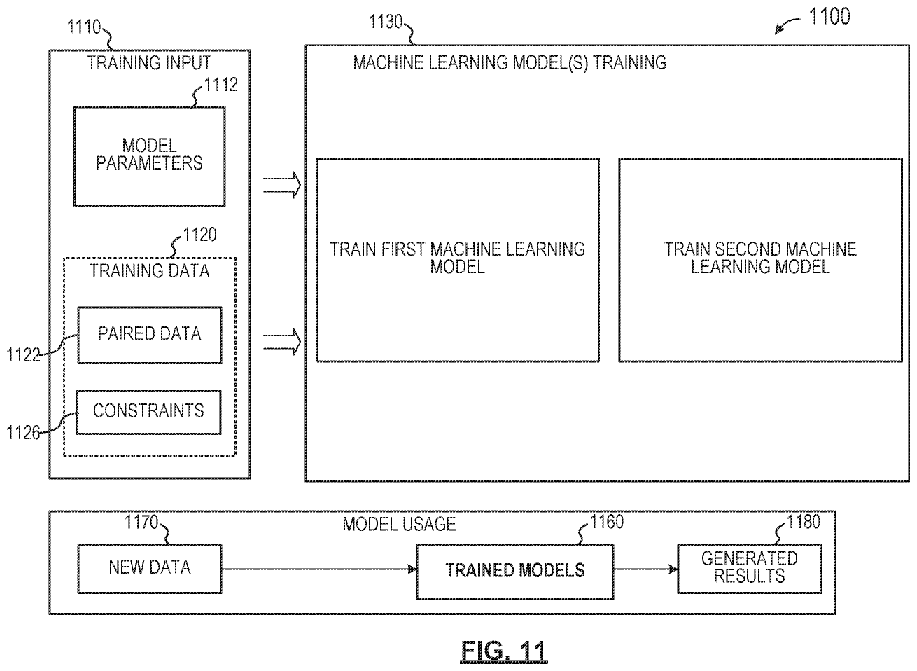

FIG. 11 is a block diagram of an example service of feature template management platform 1100 that may be deployed within the system of FIG. 4, according to some examples. Training input 1110 includes model parameters 1112 and training data 1120, which may include paired training data sets 1122 (e.g., input-output training pairs) and constraints 1126. Model parameters 1112 stores or provides the parameters or coefficients of corresponding ones of machine learning models. During training, these parameters 1112 are adapted based on the input-output training pairs of the training data sets 1122. After the parameters 1112 are adapted (after training), the parameters are used by trained models 1160 to implement the trained machine learning models on a new set of data 1170, to generate results 1180.

Training data 1120 includes constraints 1126 which may define the constraints of a given patient information features, medical or prescription claims data features, etc. The paired training data sets 1122 may include sets of input-output pairs, such as pairs of a plurality of medicinal drug prescription features and features of entities associated with the medicinal drug prescriptions, pairs of patient information and medical or prescription claims data, etc. Some components of training input 1110 may be stored separately at a different off-site facility or facilities than other components.

Machine learning model(s) training input 1110 trains one or more machine learning techniques based on the sets of input-output pairs of paired training data sets 1122. For example, the model training 1130 may train the machine learning (ML) model parameters 1112 by minimizing a loss function based on one or more ground-truth data.

The ML models can include any one or combination of classifiers or neural networks, such as an artificial neural network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, and the like.

Particularly, a first ML model of the ML models can be applied to a training batch of medicinal drug prescription features to estimate or generate a prediction of entities associated with the medicinal drug prescription features. In some implementations, a derivative of a loss function is computed based on a comparison of the estimated entities of the medicinal drug prescription and the ground truth entities of the medicinal drug prescription and parameters of the first ML model are updated based on the computed derivative of the loss function. The result of minimizing the loss function for multiple sets of training data trains, adapts, or optimizes the model parameters 1112 of the corresponding first ML model. In this way, the first ML model is trained to establish a relationship between a plurality of training medicinal drug prescriptions and ground-truth entities of the medicinal drug prescriptions.

A second ML model of the ML models can be applied to a training batch of patient information features to estimate or generate a prediction of patient medical or prescription claims status. In some implementations, a derivative of a loss function is computed based on a comparison of the estimated medical or prescription claims status and the ground truth medical signature of the medicinal medical or prescription claims status and parameters of the second ML model are updated based on the computed derivative of the loss function. The result of minimizing the loss function for multiple sets of training data trains, adapts, or optimizes the model parameters 1112 of the corresponding second ML model. In this way, the second ML model is trained to establish a relationship between a plurality of training patient information entities and ground-truth medical or prescription claims.

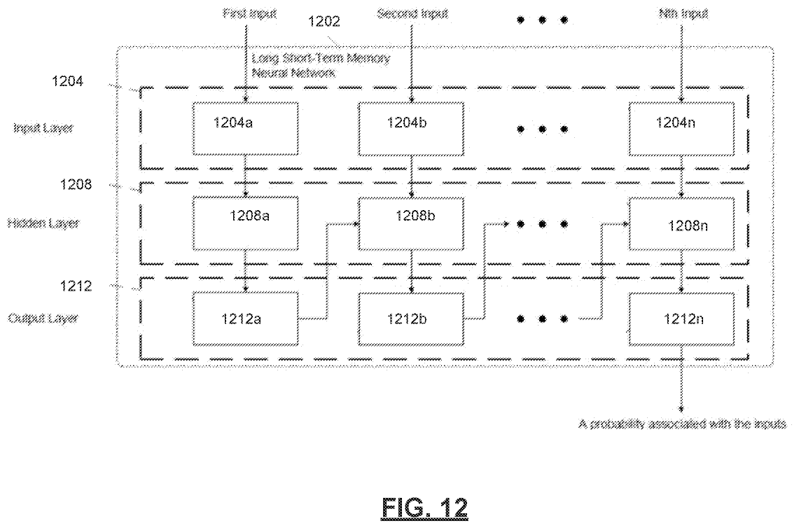

FIG. 12 is a functional block diagram of an example neural network 1202 that can be used for the inference engine or other functions (e.g., engines) as described herein to produce a predictive model. The predictive model can identify or generate entities for patient information or medical or prescription claim features. In an example, the neural network 1202 can be a LSTM neural network. In an example, the neural network 1202 can be a recurrent neural network (RNN). The example neural network 1202 may be used to implement the machine learning as described herein, and various implementations may use other types of machine learning networks. The neural network 1202 includes an input layer 1204, a hidden layer 1208, and an output layer 1212. The input layer 1204 includes inputs 1204a, 1204b . . . 1204n. The hidden layer 1208 includes neurons 1208a, 1208b . . . 1208n. The output layer 1212 includes outputs 1212a, 1212b . . . 1212n.

Each neuron of the hidden layer 1208 receives an input from the input layer 1204 and outputs a value to the corresponding output in the output layer 1212. For example, the neuron 1208a receives an input from the input 1204a and outputs a value to the output 1212a. Each neuron, other than the neuron 1208a, also receives an output of a previous neuron as an input. For example, the neuron 1208b receives inputs from the input 1204b and the output 1212a. In this way the output of each neuron is fed forward to the next neuron in the hidden layer 1208. The last output 1212n in the output layer 1212 outputs a probability associated with the inputs 1204a-1204n. Although the input layer 1204, the hidden layer 1208, and the output layer 1212 are depicted as each including three elements, each layer may contain any number of elements. Neurons can include one or more adjustable parameters, weights, rules, criteria, or the like.

In various implementations, each layer of the neural network 1202 must include the same number of elements as each of the other layers of the neural network 1202. For example, training features (e.g., collections of patient information, health insurance coverage information, historical medical or prescription claims data, etc.) may be processed to create the inputs 1204a-1204n.

The neural network 1202 may implement a first model to produce one or more entity labels associated with patient information, medical or prescription claims data, etc. More specifically, the inputs 1204a-1204n can include fields of the patient information, medical or prescription claims data, etc., as data features (binary, vectors, factors or the like) stored in a storage device. The features of the patient information, medical or prescription claims data, etc., can be provided to neurons 1208a-1208n for analysis and connections between the known facts. The neurons 1208a-1208n, upon finding connections, provides the potential connections as outputs to the output layer 1212, which determines a set of entities associated with a prescription, with patient information, with medical or prescription claims data, etc.

In some examples, a convolutional neural network may be implemented. Similar to neural networks, convolutional neural networks include an input layer, a hidden layer, and an output layer. However, in a convolutional neural network, the output layer includes one less output than the number of neurons in the hidden layer and each neuron is connected to each output. Additionally, each input in the input layer is connected to each neuron in the hidden layer. In other words, input 1204a is connected to each of neurons 1208a, 1208b . . . 1208n.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computer system comprising:
a database configured to store a feature template repository, the feature template repository including multiple feature templates configured for building predictive models, each of the multiple feature templates including a parameterized structured query language (SQL) query; and
processor hardware configured to execute instructions to
search the feature template repository for a target predictive model feature,
in response to a determination that the target predictive model feature does not have a matching feature template in the feature template repository, create a new feature template for the target predictive model feature by defining feature logic for the new feature template and defining an SQL query for the new feature template,
submit the new feature template for approval by generating a notification including a repository link, and
in response to receiving an approval, upload the new feature template to the feature template repository for use in building predictive models.

2. The computer system of claim 1, wherein the processor hardware is configured to execute a predictive model including at least one predictive model feature based on the new feature template uploaded to the feature template repository.

3. The computer system of claim 1, wherein the new feature template includes a template folder structure including an SQL folder and a configuration folder.

4. The computer system of claim 3, wherein:
the SQL folder is configured to store an SQL file including the SQL query defined for the new feature template; and
the configuration folder is configured to store a configuration file including one or more parameters of the SQL query.

5. The computer system of claim 3, wherein:
the template folder structure includes a builder folder; and
the builder folder is configured to store a builder file defining at least one non-SQL processing function.

6. The computer system of claim 1, wherein the processor hardware is configured to execute the new feature template via an Auchan application programming interface (API).

7. The computer system of claim 6, wherein the processor hardware is configured to return output features as a Spark feature table.

8. The computer system of claim 1, wherein in response to a determination that the target predictive model feature has a matching feature template in the feature template repository, the processor hardware is configured to implement the matching feature template as a portion of a predictive model.

9. The computer system of claim 1, wherein creating the new feature template includes identifying one or more parameters associated with target predictive model feature.

10. The computer system of claim 9, wherein the one or more parameters include at least one healthcare claim parameter.

11. The computer system of claim 1, wherein in response to a receiving a denial subsequent to submitting the new feature template, the processor hardware is configured to modify the new feature template and resubmit the modified new feature template for approval.

12. A method for predictive model feature template creation, the method comprising:
searching a feature template repository for a target predictive model feature, the feature template repository including multiple feature templates configured for building predictive models, each of the multiple feature templates including a parameterized structured query language (SQL) query;
in response to a determination that the target predictive model feature does not have a matching feature template in the feature template repository, creating a new feature template for the target predictive model feature by defining feature logic for the new feature template and defining an SQL query for the new feature template;
submitting the new feature template for approval by generating a notification including a repository link; and
in response to receiving an approval, uploading the new feature template to the feature template repository for use in building predictive models.

13. The method of claim 12, further comprising executing a predictive model including at least one predictive model feature based on the new feature template uploaded to the feature template repository.

14. The method of claim 12, wherein the new feature template includes a template folder structure including an SQL folder and a configuration folder.

15. The method of claim 14, wherein:
the SQL folder is configured to store an SQL file including the SQL query defined for the new feature template; and
the configuration folder is configured to store a configuration file including one or more parameters of the SQL query.

16. The method of claim 14, wherein:
the template folder structure includes a builder folder; and
the builder folder is configured to store a builder file defining at least one non-SQL processing function.

17. The computer system of claim 1, further comprising executing the new feature template via an Auchan application programming interface (API).

18. The computer system of claim 17, further comprising returning output features as a Spark feature table.

19. The method of claim 12, wherein in response to a determination that the target predictive model feature has a matching feature template in the feature template repository, the method includes implementing the matching feature template as a portion of a predictive model.

20. The method of claim 12, wherein creating the new feature template includes identifying one or more parameters associated with target predictive model feature.
